(19) United States
(12) Patent Application Publication
(10) Pub. No.: US 2021/0252828 A1
(43) Pub. Date: Aug. 19, 2021

(54) Decorative material composite that can be backlit, in particular for the interior fittings of motor vehicles

(71) Applicant: EISSMANN AUTOMOTIVE DEUTSCHLAND GMBH, BAD URACH (DE)

(72) Inventors: NORMAN EITEL, ENINGEN (DE); JENNIFER TOPP, PFULLINGEN (DE)

(21) Appl. No.: 17/176,303

(22) Filed: Feb. 16, 2021

(30) Foreign Application Priority Data
Feb. 17, 2020 (DE) 102020104078.4

(51) Int. Cl. B32B 7/023; B32B 5/18; B32B 5/02; B32B 5/26; B32B 5/24; B32B 7/12; B32B 38/00

(52) U.S. Cl. CPC B32B 7/023; B32B 5/18; B32B 5/026; B32B 5/26; B32B 5/245; B32B 2255/02; B32B 38/145; B32B 2307/412; B32B 2307/4023; B32B 2605/003; B32B 7/12

(57) ABSTRACT

The invention relates to a decorative material composite (10), in particular for the interior fittings of motor vehicles, comprising a flat decorative material (11), which is permeable to light, and a visible side (14) and a rear side (13) opposite the visible side (14), wherein a printable diffuser (20) is arranged on the rear side (13) of the decorative material (11), wherein, in a sub-region, a layer (30) at least substantially impermeable to light is applied, and in particular printed, onto the side of the diffuser (20) facing away from the decorative material (11), wherein the regions (31) left blank by the layer (30) impermeable to light depict information, patterns or symbols, wherein the decorative material composite (10) serves to be backlit with an illumination device (40) and to allow a part of the light of the illumination device (40) to pass through the regions (31) left blank to the visible side (14) of the decorative material (11).

The present invention also relates to its use and a production method.

### CROSS-REFERENCE TO RELATED APPLICATIONS

This application claims priority to German patent application: DE 10 2020 104 078.4, filed 17 Feb. 2020, having a common inventor and currently pending.

### STATEMENT REGARDING FEDERALLY SPONSORED RESEARCH OR DEVELOPMENT

Not Applicable.

### BACKGROUND OF THE INVENTION

### Field of the Invention

The present invention relates to a decorative material composite that can be backlit, in particular for the interior fittings of motor vehicles, and a production method for such a decorative material composite.

### DESCRIPTION OF RELATED ART

In the field of vehicle interior design, it is common to line support elements such as instrument panels, interior door panels, vehicle headliners or central consoles with flat decorative materials such as leather, artificial leather, alcantara, decorative foils, textiles or other flat fabrics. The flat decorative material is often not lined directly onto the support element, but rather a knitted spacer fabric or foam is provided between support element and decorative material in order to convey an attractive haptic impression.

Solvent, dispersion or hot-melt adhesives are generally used for adhering the layers.

A trend for backlit surfaces has emerged in recent years. For this, in principle, a light guide is applied onto a carrier material, said light guide being illuminated with a light source such as an LED light. An at least partially transparent layer is provided above the light guide. When used at night, i.e. when the light source is switched on, the light from the light source is led through the light guide and then, at points of the partially transparent layer permeable to light, passes through this layer and into the interior of the motor vehicle. In order to achieve even spatial light distribution, a diffusor is often provided between the light guide and the partially light-permeable layer.

With such surfaces that are, or are able to be, backlit, in particular in darkness, an attractive basic illumination can be obtained in the interior of the motor vehicle, wherein, in lightness, the light source is virtually invisible.

In the field of upscale vehicle interior design, there is the desire to provide switching surfaces and imagery in parts of the paneling which only become visible when needed. This means that, with a so-called “day design” in which the decorative material is not backlit, the viewer only sees the surface of the decorative material. In the “night design”, i.e. as soon as the decorative material is backlit, a specific design, for example lettering or symbols, for example for making switching surfaces discernible, appears on the visible side of the decorative material.

A decorative composite and a method for producing a decorative composite having a decorative layer, which is provided with a perforation, wherein openings are formed in the decorative layer, and at least one transparent decorative layer are known from DE 10 2008 054 721 B3, wherein the decorative layer has at least one scattering portion which locally enlarges the degree of scattering of the covering layer.

A decorative part formed as a moulded part for a vehicle interior having a decorative layer formed from a plastic foil, on the rear side of which decorative layer a carrier is arranged, is known from DE 20 2016 100 258 U1, wherein the plastic foil has a printing ply impermeable to light having at least one recess for guiding light through at least on one side.

DE 10 2015 220 853 A1 discloses a surface element for a motor vehicle.

A decorative composite is known from DE 10 2008 041 701 A1 in which perforations are introduced in the decorative layer in such a way that lines, ornaments or symbols, for example, are depicted. The regions with the perforations can be backlit in order to make visible the imagery that is to be depicted.

A disadvantage consists in that, when a plurality of perforations is introduced to depict the imagery, the decorative material increasingly loses stability, such that the decorative material is inclined to warp or the region of the perforations becomes visibly apparent. In addition, the corresponding production method is laborious.

The object of the present invention is to provide a decorative material composite that can be backlit, by means of which imagery can be depicted without losing stability and which can be attractively and simply produced in industrial batch production. The object of the present invention is also to specify a production method relating to this.

### BRIEF SUMMARY OF THE INVENTION

The decorative material composite according to the invention, in particular for the interior fittings of motor vehicles, comprises a flat decorative material which is permeable to light and has a visible side and a rear side opposite the visible side. A printable diffuser is arranged on the rear side of the decorative material, wherein, in a sub-region, at least one layer that is substantially impermeable to light is applied, and in particular printed, onto the side of the diffuser facing away from the decorative material. The regions left blank by the layer impermeable to light depict information, patterns or symbols. In one embodiment, the diffuser is a transparent foil or a transparent adhesive film which is printed substantially over the entire surface with a diffuser layer. The decorative material composite serves to be backlit with an illumination device and to allow part of the light of the illumination device to pass through the regions left blank to the visible side of the decorative material. In one embodiment, a transparent carrier is arranged below the layer impermeable to light and/or the filler layer or the haptic layer.

The decorative material composite can be backlit by an illumination device, such that part of the light of the illumination device can pass through the decorative material composite to the visible side of the decorative material.

Since a layer impermeable to light is provided in certain regions on the side of the decorative material composite facing away from the visible side of the decorative material, the decorative material composite is only permeable to light in the regions not provided by the layer impermeable to light.

As a result of the arrangement of the diffuser on the rear side of the decorative material, light penetrating from the visible side through the decorative material partially permeable to light backscatters. Thus, the layers which are below the decorative material cannot be seen from the visible side if there is no rear-sided illumination present.

Thus the appearance of the decorative material (without back-illumination) is determined only by the appearance of the surface of the decorative material itself. For example, if it is a textile, then only the structure of the textile is recognizable when viewed from the visible side.

In this so-called day design, i.e. without through-illumination of the decorative material composite, the surface of the decorative material appears in the material properties of the decorative material when seen from the visible side.

If the decorative material composite which is provided in certain regions with the layer impermeable to light corresponding to the desired symbols is now backlit, the light penetrates through the regions of the layer impermeable to light that have been left blank. Anywhere the layer impermeable to light is applied or printed onto the diffuser, the light is absorbed. Thus, in the night design when backlit, the regions left blank by the layer impermeable to light appear to be bright.

In this so-called night design, the surface or the visible side of the decorative material appears in a specific design deviating from the day design which is determined by the arrangement of the regions of the layer impermeable to light on the diffuser.

It is essential that the illumination device be arranged behind the layer impermeable to light applied in a sub-region, since otherwise back-lighting according to the invention is not possible.

The diffuser also ensures that the decorative material is illuminated from its rear side with diffuse light. In particular, it can thus be ensured that the symbols of the night design can be easily recognizable from a large range of angles.

According to the invention, the diffuser can be printed so that the layer impermeable to light can be applied on its side facing away from the decorative material in the regions required for the symbols. This means that the diffuser can serve as the carrier for printing inks or pigments. At the same time, the diffuser prevents the printing inks or pigments being able to penetrate into the decorative layer. Printable also means that the printing inks or pigments adhere fixedly on the diffuser, i.e. cannot be released during the intended use.

A light-scattering foil or a light-scattering adhesive film can be used as the diffuser.

In a further variant, the diffuser is produced from a transparent foil or a transparent adhesive film by means of substantially all-over printing with a diffuser layer, for example a colour. Substantially all-over means that the diffuser layer is also applied anywhere light is to pass through. Edge regions covered by other components, for example, can be left blank.

This variant is advantageous since conventional foils or adhesive films can be used, and the colour of the diffuser layer can be individually chosen, and thus the diffuser layer can be produced in a cost effective manner.

In both variants, the diffuser can be white or light or coloured or preferably in roughly the same colour as the decorative material.

In the scope of this invention, white and black are also referred to as “coloured” or “colours”.

The foil can be a common foil with an adhesive coating or a hot-melt adhesive foil, in particular based on polyurethane on an ester basis, or a thermoplastic adhesive film. However it is essential that the foil can be printed.

The decorative material is a soft, flat material such as leather, artificial leather, plastic, alcantara or a decorative foil. In particular, the decorative material is a textile material.

The decorative material is permeable to light. According to the invention, “permeable to light” is to be understood to mean that light from the illumination device can be allowed to at least partially pass through. For example, perforated leather can also be a material permeable to light.

Particularly preferably, textile substances are used as the decorative material. Advantageously, because of the mesh width, textiles do not have to be additionally perforated. Thus, additional work steps can be omitted and costs saved.

Textiles that are tightly sewn, tightly knitted or tightly woven are preferred.

A further advantage of textiles is that the light permeability of the decorative material can be adjusted both by the thickness of the textile and by the mesh width.

The narrower the mesh width, the more sharply the contours of the symbols can be depicted in the night design on the visible side of the decorative material.

The layer thickness of the decorative material is preferably between 0.5 mm and 2.5 mm and particularly preferably between 0.8 mm and 1.5 mm.

In a sub-region, the layer impermeable to light is printed on the side of the diffuser which is facing away from the decorative material. To do so, all suitable printing processes can be used, such as laser printing, inkjet printing, silkscreen printing or digital printing, for example.

According to the invention, the layer impermeable to light is not applied to the diffuser all over, but rather only in a sub-region, since otherwise no symbols would be able to be depicted.

Below, the layer impermeable to light printed in a sub-region on the side of the diffuser facing away from the decorative material is simply referred to as the layer regionally impermeable to light.

Preferably, the layer regionally impermeable to light comprises printing inks, pigments or metallic particulates. Preferably, the layer impermeable to light is black.

Particularly preferably, the layer regionally impermeable to light is made of toner which usually comprises artificial resin, pigments, magnetizable metallic oxides and various excipients. Other dyes are of course also suitable for electrostatic printing methods.

Substantially impermeable to light means that the light which is provided by the illumination device and which falls on the layer impermeable to light is absorbed by the layer impermeable to light to such an extent that this light can substantially no longer be perceived when seen from the visible side.

The regions which are not printed with the layer impermeable to light depict a piece of information, a pattern, a symbol or similar. This means that the regions left blank determine the night design.

If a symbol or a letter on the visible side of the decorative material is now supposed to be visible in the night design, then exactly the regions in the shape of this symbol or letter are left blank from the layer impermeable to light or these regions are not printed.

Thus, the light provided by the illumination device is only absorbed by the layer impermeable to light in the regions printed onto the diffuser. In the regions left blank, the light can then penetrate the diffuser, and the diffuse light passes through from the rear side of the decorative material to the visible side of the decorative material. There, the piece of information is thus visible in the night design.

For example, functional elements such as switching surfaces, driver information or warning indicators and/or design elements such as lettering, logos or graphics are displayed in the night design as information.

If necessary, in order to compensate for height differences which could emerge as a result of the recesses in the layer regionally impermeable to light and could be haptically perceptible, a filler layer can be provided on the diffuser in the regions in which a layer impermeable to light is not applied.

The filler layer is permeable to light and applied on the diffuser at least in the regions in which the layer impermeable to light has been left blank.

Alternatively, the filler layer can also additionally be applied on the layer regionally impermeable to light, that is in such a way that the filler layer penetrates into the regions left blank and is in contact with the diffuser in the regions which are left blank. Thus, the filler layer compensates for any unevenness which emerges as a result of the regions left blank.

A haptic layer can be arranged below, i.e. on the side facing away from the decorative material, the layer regionally impermeable to light or the filler layer. The haptic layer can be a foam or a knitted spacer fabric and is preferably adhered to the decorative material composite.

A carrier can be provided below the haptic layer.

Alternatively, the carrier can be adhered directly to the layer regionally impermeable to light and/or the filler layer.

Transparent or semi-transparent plastics are considered as the material for the carrier. A semi-transparent plastic is preferably used.

If the illumination device is arranged on the rear side of the haptic layer or the carrier, the haptic layer or the carrier must be transparent.

The illumination device comprises a light source such as an LED light, for example. In addition, the illumination device can also comprise a light guide, for example made of silicone or a plastic, a light diffuser and a reflector.

In order to produce a decorative material composite according to the invention that can be backlit, the fabric decorative material is provided with a visible side and a rear side opposite the visible side. The printable diffuser is applied on the rear side of the decorative material, in particular by means of adhesion. Then, a layer at least substantially impermeable to light is regionally applied onto the diffuser.

The invention is described in more detail below by means of exemplary embodiments.

### BRIEF DESCRIPTION OF THE DRAWINGS

FIG. 1 a schematic sectional depiction of the decorative material composite,

FIG. 2 the decorative material composite from FIG. 1 with a haptic layer and a transparent layer,

FIG. 3 a variant of the decorative material composite according to the invention,

FIG. 4 a schematic sectional depiction of the decorative material composite with filler layer,

FIG. 5 a variant of the embodiment according to FIG. 4,

FIG. 6A a schematic view of the visible side in the day design, and,

FIG. 6B a schematic view of the visible side in the night design.

### DETAILED DESCRIPTION OF THE INVENTION

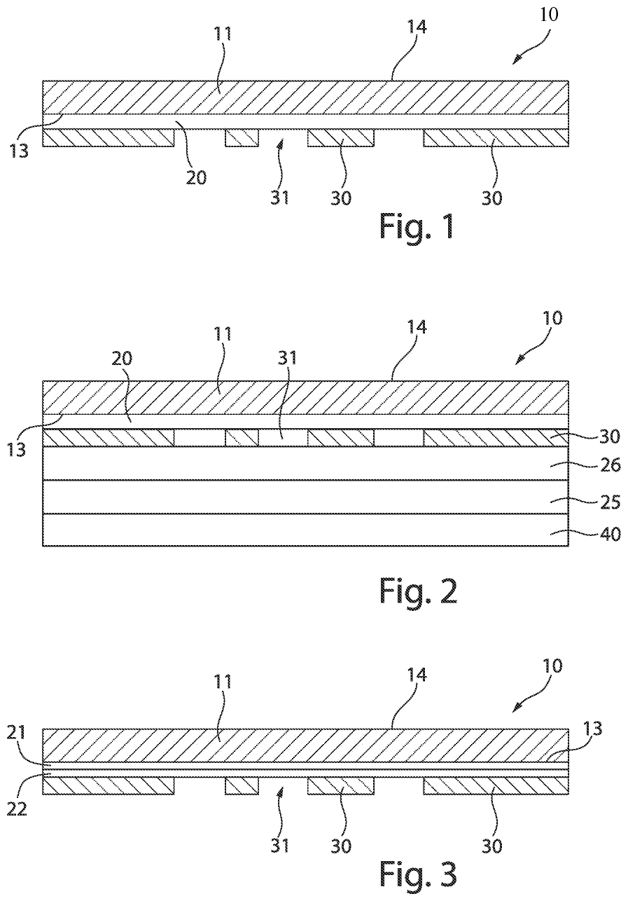

The decorative material composite 10 in FIGS. 1 to 5 points upwards into the interior of the vehicle with the visible side 14 of the decorative material 11.

In a first exemplary embodiment according to FIG. 1, the decorative material 11 with its rear side 13 is adhered all over to the diffuser 20. The diffuser 20 is a white foil which is adhered onto the rear side 13 of the decorative material 11.

In sub-regions, the layer 30 impermeable to light is printed onto the rear side of the diffuser 20. Here, regions 31 are left blank which are visible with through-illumination, i.e. in the night design, on the visible side 14 as a piece of information (see FIG. 6).

In this embodiment, the layer 30 regionally impermeable to light consists of toner. However, the layer 30 impermeable to light can also be applied with other printing methods. In such cases, the layer 30 regionally impermeable to light then consists of the printing inks used in these printing methods.

In the embodiment according to FIG. 2, the decorative material composite 10 is adhered to a haptic layer 26 with the side of the layer 30 regionally impermeable to light facing away from the decorative material 11. The haptic layer 26 is either a knitted spacer fabric or a foam. This composite can then be adhered to a carrier 25, for example a door panel, via the underside of the haptic layer 26. Of course, the haptic layer 26 can also firstly be adhered to the carrier 25 and then adhered onto the decorative material composite 10. Similarly, with the layer construction, the haptic layer 26 can also be omitted and the decorative material composite 10 applied directly onto the carrier 25.

An illumination device 40 is arranged behind the carrier 25.

The haptic layer 26 and the carrier 25 are permeable to light.

In a variant depicted in FIG. 3, the diffuser 20 is bipartite. The diffuser 20 comprises a transparent foil 21 which is adhered to the decorative material 11 over the entire surface and is printed with a coloured layer 22. For this, the common printing methods can be used, such as laser printing or inkjet printing, for example. If laser printing is used, then the coloured layer 22 is a layer made of toner.

The coloured layer 22 is white, such that incident light is scattered from the visible side 14 of the decorative material 11 outwards. Light arriving at the coloured layer 22 from the illumination device 40 (not depicted in FIG. 3), arranged below the layer 30 regionally impermeable to light, through the regions 31 left blank, is partially scattered by the coloured layer 22. A majority of the light reaches through the foil 21 and the decorative material 11 to the visible side 14.

The same effect is also achieved by the monobloc diffuser 20 from the first exemplary embodiment.

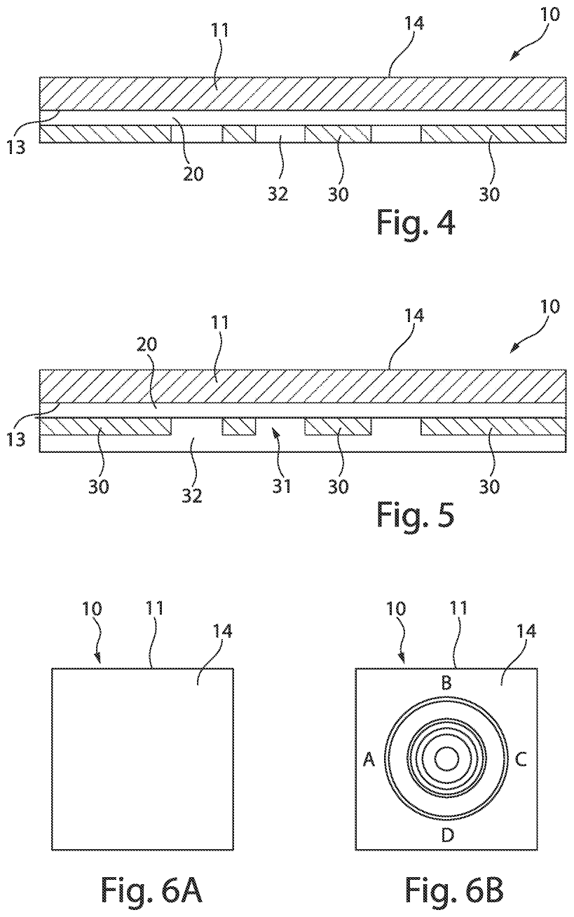

In a further variant, the regions 31 left blank are filled with a transparent filler layer 32 (FIG. 4). Here, these can be printing inks, lacquer or a foil, for example. However, the filler layer 32 is optional and can be used in order to avoid marks to the regions 31 left blank as a result of the height difference.

Alternatively, the transparent filler layer 32 can also extend all-over across the layer 30 impermeable to light and into the regions 31 left blank (FIG. 5).

If no light is provided by the illumination device 40, then the surroundings light which reaches through the decorative material 11 from the visible side 14 is scattered by the diffuser 20. This leads to the layers lying below the diffuser 20 not being visible from the visible side 14. In a “day design,” a viewer, for example an occupant in a vehicle, only sees the surface of the decorative material 11, as depicted in FIG. 6A. The day design is thus determined by the surface properties of the decorative material 11.

If the illumination device 40 is now switched on, then the light provided passes through the regions 31 left blank of the layer 30 impermeable to light. It reaches through the diffuser 20, is scattered diffusely and passes through the decorative material 11 to the visible side 14. The “night design” is now visible to a viewer on the visible side 40 (FIG. 6B). Symbols, letters or switching surfaces appear on the visible side 14. These through-illuminated surfaces illuminate and correspond exactly in terms of their shape to the shape of the regions 31 left blank.

We claim:

1. Decorative material composite comprising a decorative material layer, which is permeable to light, and having a visible side and a rear side opposite the visible side, wherein a diffuser is arranged on the rear side of the decorative material layer, wherein the diffuser is a transparent foil or a transparent adhesive film which is printed substantially over its entire surface with a diffuser layer, wherein, in a sub-region of the diffuser, a layer at least substantially impermeable to light is applied, onto a side of the diffuser facing away from the decorative material layer, wherein regions left blank by the layer substantially impermeable to light depict information, patterns or symbols, and wherein the decorative material composite is backlit with an illumination device and a part of the light of the illumination device passes through the regions left blank to the visible side of the decorative material layer.

2. Decorative material composite according to claim 1, wherein the layer at least substantially impermeable to light is printed onto the side of the diffuser facing away from the decorative material layer.

3. Decorative material composite according to claim 1, wherein the diffuser is white or bright or coloured or the same colour as the decorative material layer, or is printed with a coloured layer which is white or bright or the same colour as the decorative material.

4. Decorative material composite according to claim 1, wherein the decorative material layer is a soft decorative material made of at least one selected from leather, artificial leather, alcantara, plastic decorative foil and a textile.

5. Decorative material composite according to claim 1, wherein the layer impermeable to light comprises printing ink or pigments or metallic particles or is black.

6. Decorative material composite according to claim 1, wherein a filler layer is applied on the diffuser at least in the regions in which the layer impermeable to light is not applied.

7. Decorative material composite according to claim 1, wherein the decorative material composite is adhered to a haptic layer with its side of the layer impermeable to light facing away from the decorative material and, where necessary, with the filler layer.

8. Decorative material composite according to claim 1, wherein a transparent carrier is arranged below the layer impermeable to light and/or the filler layer or the haptic layer.

9. Method for producing a decorative material composite that can be backlit, which comprises the following steps:
a) providing a decorative material layer with a visible side and a rear side opposite the visible side;
b) applying a printable diffuser onto the rear side of the decorative material layer;
c) printing a layer that is substantially impermeable to light on a sub-region on a side of the diffuser facing away from the decorative material layer.

10. Method according to claim 9, wherein the layer substantially impermeable to light sub-region is applied by means of laser printing, inkjet printing, silkscreen printing or digital printing.

11. Use of a decorative material composite according to claim 1 as an interior design part of a motor vehicle or for the interior fittings of motor vehicles.

12. Decorative material composite according to claim 1, wherein the diffuser is a polyurethane on an ester basis foil with an adhesive coating or a hot-melt adhesive foil or a thermoplastic adhesive film.

13. Decorative material composite according to claim 12, wherein the hot-melt adhesive foil is based on polyurethane on an ester basis.

14. Decorative material composite according to claim 1, wherein a thickness of the decorative material layer is between 0.5 mm and 2.5 mm.

15. Decorative material composite according to claim 1, wherein a thickness of the decorative material layer is between 0.8 mm and 1.5 mm.

16. Decorative material composite according to claim 1, wherein the illumination device is arranged behind a carrier.
